(19) United States
(12) Patent Application Publication
(10) Pub. No.: US 2009/0130500 A1
(43) Pub. Date: May 21, 2009

(54) METHOD OF OPERATING A FUEL CELL STACK AT LOW PRESSURE AND LOW POWER CONDITIONS

(76) Inventors: Boguslaw M. Wozniczka, Coquitlam (CA); Alfred N.F. Wong, Vancouver (CA); Kevin M. Colbow, West Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/119,676

(22) Filed: May 13, 2008

Related U.S. Application Data
(63) Continuation of application No. PCT/US2005/041863, filed on Nov. 18, 2005.

(51) Int. Cl. H01M 8/00; H01M 8/02

(52) U.S. Cl. 429/13

(57) ABSTRACT

A method of operating a low pressure drop fuel cell stack comprising a plurality of low pressure drop fuel cells wherein during low pressure and low power operation, a heat transfer rate of a cathode flow field plate of each fuel cell is greater than a heat transfer rate of an anode flow field plate of the same fuel cell. Thus, a temperature gradient is created between an anode electrode and a cathode electrode of each fuel cell, as well as reactant fluids in at least one anode flow field and at least one cathode flow field of the same fuel cell.

### CROSS-REFERENCE TO RELATED APPLICATION

This application is a continuation of PCT Application No. PCT/US2005/041863, filed Nov. 18, 2005, now pending, which application is incorporated herein by reference in its entirety.

### BACKGROUND

1. Technical Field

The present invention relates to a method of operating fuel cell stacks, in particular, operating solid polymer fuel cell stacks under low pressure and low power operating conditions.

2. Description of the Related Art

Electrochemical fuel cells convert fuel and oxidant into electricity. Solid polymer electrochemical fuel cells generally employ a membrane electrode assembly that includes an ion exchange membrane or solid polymer electrolyte disposed between two electrodes typically comprising a layer of porous, electrically conductive sheet material, such as carbon fiber paper or carbon cloth. The membrane electrode assembly comprises a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of membrane electrode assemblies are electrically coupled in series to form a fuel cell stack having a desired power output.

The membrane electrode assembly is typically interposed between two electrically conductive bipolar flow field plates or separator plates wherein the bipolar flow field plates may comprise polymeric, carbonaceous, graphitic, or metallic materials. These bipolar flow field plates act as current collectors, provide support for the electrodes, and provide passages for the reactants and products. Such bipolar flow field plates may comprise flow fields to direct the flow of the fuel and oxidant reactant fluids to the anode and cathode electrodes of the MEA, respectively, and to remove excess reactant gases and reaction products, such as water formed during fuel cell operation.

A certain amount of pressure is typically needed to deliver reactant fluids to the fuel cell and to run other fuel cell system components, all of which governs the operating pressure of the fuel cell. Thus, during fuel cell stack operation, the reactant streams are typically pressurized to an operating pressure by means of a compressor, pump, blower, fan, or the like. In most cases, a lower operating pressure is desirable in order to lower the amount of parasitic power that is needed to pressurize the anode and cathode reactant streams. Specifically, a high efficiency blower or fan is desirable to pressurize the reactant streams because it consumes a lower amount of parasitic power than compressors and pumps. However, most commercially available blowers and fans pressurize the reactants to significantly lower pressures than conventional fuel cells, for example, up to 0.21 barg, thereby undesirably limiting the highest operating pressure.

During regular fuel cell operation, water is produced at the cathode, which may condense into water droplets within the catalyst layer, within the gas diffusion layer, in the reactant flow fields, or surfaces thereof. An excess of water droplets is undesirable because the water droplets contribute to unstable performance (for example, water “flooding” in the anode and/or cathode), and may cause non-uniform reactant fluid flow and reactant starvation.

The most common approaches to solving this problem are to increase the pressure drop of the flow fields, supply a greater amount of reactant fluid than stoichiometrically required, operate at a higher operating pressure, and/or increase the operating temperature.

For example, the anode and cathode flow field geometry may be designed to have a high pressure drop to passively enhance the flow of reactant fluids through the fuel cell and the removal of reactant product fluids, for example, water, out of the fuel cell. However, this results in an increase in the operating pressure to compensate for the pressure drop of the flow fields, thus increasing parasitic power consumption and decreasing fuel efficiency. Thus, pressure drop in the flow fields is usually minimized, for example, to as low as 150 mbar, particularly for low pressure fuel cells. However, when operating low pressure fuel cells at low power, unstable fuel cell performance is often observed because a low amount of reactants are delivered to the fuel cells, thereby resulting in a reactant flow velocity that is inadequate to clear excessive liquid water in the flow fields of the low pressure fuel cell, particularly in the anode flow fields wherein the stoichiometry is typically minimized to maximize fuel efficiency.

Alternatively, water may be removed by supplying an excess of reactants to the anode and cathode flow fields, increasing the reactant pressure, or increasing the operating temperature. The former methods remove water droplets by inducing a shearing force to get rid of excess liquid water in the cathode while the latter method removes water droplets by evaporating the liquid water in the fuel cell. However, all of these methods are also undesirable because they increase parasitic power consumption and decrease fuel efficiency.

One method of clearing excess water in the flow fields is described in Published U.S. Pat. Appl. No. 2004/0137293, wherein a fuel cell system and its control method is capable of removing condensed water only from a place where flooding is generated. Heating means is arranged on a separator and its switch is turned on when the moisture for hydration of an electrolyte membrane is condensed, so that current is supplied to the heating means from a power source so as to evaporate the condensed water. Heating means is provided on at least one of the separators, and actuation and de-actuation of the heating means is controlled according to the state of the fuel cell. However, power consumption is increased and fuel efficiency is decreased in order to run other system components to evaporate or remove excess liquid water.

Another method is described in Published PCT No. WO 2004/107839 wherein the temperatures of cathodes of fuel cells are maintained sufficiently above the temperatures of corresponding anodes either before, during, or after cold starts and after freeze-thaw cycles to cause migration of water from cathodes to anodes, thereby imposing a temperature differential between the electrodes by warming the cathode side or cooling the anode side, so as to influence the flow of water, causing it to be more toward the anode, to preserve or restore performance. Temperatures may be controlled by heaters or by heating process air, by flowing air through just the anode to be cooled by vaporization, by flowing air through both anodes and the cathodes, the cathode's air being warmer, or by bleeding H₂ into cathodes momentarily. Again, these methods consume extra parasitic power in order to prevent water from excessively flooding the cathode or to evaporate excess water, thereby preventing/recovering fuel cell performance loss due to cathode flooding.

During low power operation (for example, at a current density of less than 0.5 A/cm²), water produced at the cathode may migrate to the anode due to a water vapor pressure differential between the fuel stream and the oxidant stream in the anode and cathode flow fields, respectively, thus resulting in anode flooding. Anode flooding is difficult to mitigate because fuel is usually supplied at a stoichiometry that is as low as possible in order to maximize fuel efficiency while sustaining the required power generation. Furthermore, when running at low pressure (for example, in cases when blowers and/or fans are used to deliver the reactants to the fuel cell stack), the reactant flow velocity is insufficient to remove the condensed water vapor in the anode flow fields, thereby increasing performance instability.

Accordingly, there remains a need in the art to minimize unstable performance of a fuel cell stack operating at low pressure and low power conditions. The present invention fulfills this need and provides further advantages.

### BRIEF SUMMARY

In brief, a method is provided for operating a low pressure drop fuel cell stack with improved performance stability at low pressure and low power operating conditions, wherein each fuel cell of the fuel cell stack comprises an anode flow field plate, a cathode flow field plate and a membrane electrode assembly, such that during low pressure and low power operation, the cathode flow field plate of each fuel cell has a higher heat transfer rate than the anode flow field plate of the same fuel cell.

In the practice of operating a low pressure drop fuel cell stack comprising a plurality of fuel cells wherein during low pressure and low power operation, a heat transfer rate of a cathode flow field plate of each fuel cell is greater than the heat transfer rate of an anode flow field plate of the same fuel cell. During fuel cell stack operation, the reactants are delivered to the anode flow field plate and the cathode flow field plate of each fuel cell by means of a blower or fan.

To create a higher heat transfer rate in the cathode flow field plate than the heat transfer rate in the anode flow field plate, in one embodiment, the cathode flow field plate material has a higher thermal conductivity than the anode flow field plate material, for example, by using different materials for the anode and cathode flow field plates. Thus, during low pressure and power operation of the low pressure drop fuel cell stack, heat rejection from the reactant in the cathode flow fields of each fuel cell is higher than heat rejection from the reactant in the anode flow fields of the same fuel cell, thereby keeping the cathode of each fuel cell warmer than the anode of the same fuel cell.

In another embodiment, wherein at least one of the anode and cathode flow field plates comprises coolant flow fields, the web thickness of the anode flow field plate is made greater than the web thickness of the cathode flow field plate to ensure a greater heat transfer rate in the cathode flow field plate than in the anode flow field plate. In other words, the distance of the bottom of the anode flow fields to the parallel edge of the coolant flow fields is greater than the distance of the bottom of the cathode flow fields to the opposite edge of the coolant flow fields of the bipolar flow field plate.

These and other aspects of the invention will be evident in view of the attached figures and following detailed description.

### BRIEF DESCRIPTION OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1 is a cross-sectional diagram of a bipolar flow field plate with low pressure drop anode and cathode flow fields.

FIG. 2 is a cross-sectional diagram of a low pressure drop fuel cell and fuel cell stack.

FIG. 3 is a cell voltage vs. cell position diagram showing the average performance of each cell in a first 10-cell stack using a first set of anode flow field plates.

FIG. 4 is a cell voltage vs. cell position diagram showing the average performance of each cell in a second 10-cell stack using a second set of anode flow field plates.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and/or fuel cell systems have not been shown or described in detail to avoid unnecessarily obscuring descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The invention is characterized by a method of operating a fuel cell stack at a low pressure (for example, less than 0.21 barg) and low power (for example, less than 0.5 A/cm²), wherein the performance of each fuel cell in the fuel cell stack is stabilized by establishing different heat transfer rates for the anode and cathode flow field plates of each fuel cell, such that the heat transfer rate of the cathode flow field plate of each fuel cell is greater than the heat transfer rate of the anode flow field plate of the same fuel cell.

FIG. 1 shows the cross-section of an exemplary bipolar flow field plate 2 comprising anode flow field plate 4 with anode flow fields 8 on a first surface 10 and cathode flow field plate 6 with cathode flow fields 12 on a first surface 14. To facilitate the low pressure operation, anode flow fields 8 and cathode flow fields 12 should have a low pressure drop, preferably less than 150 mbar. Anode flow field plate 4 and cathode flow field plate 6 may be adhesively joined together around a peripheral edge thereof (not shown) such that a second surface 18 of anode flow field plate 4 faces and contacts second surface 20 of cathode flow field plate 6. Alternatively, anode flow field plate 4 and cathode flow field plate 6 are not adhesively joined together. Furthermore, at least one of the second surfaces of the anode flow field plate and the cathode flow field plate may further comprise at least one coolant flow field. At least one coolant flow field for circulating a coolant fluid is typically employed for fuel cells to remove heat from the reactants in the anode and cathode flow fields, thereby keeping the fuel cell at an optimum operating temperature. In addition, the coolant fluid helps distribute heat evenly throughout the fuel cell to prevent hot spots from forming therein, which may damage components of the membrane electrode assembly (hereinafter referred to as “MEA”). For example, in FIG. 1, cathode flow field plate 6 further comprises coolant flow fields 22 on a second surface 20 of cathode flow field plate 6. In another alternative, the second surfaces of both the anode and cathode flow field plates may comprise coolant channels (not shown).

The heat transfer rate of cathode flow field plate 6 is preferably greater than the heat transfer rate of anode flow field plate 4 during operation. For example, during low pressure and low power operation, oxidant is delivered to cathode flow fields 12 by means of a blower or fan (not shown), fuel is delivered to anode flow fields 8 by means of a blower or fan (not shown) (which may optionally go through a reformer prior to entering the anode flow fields 8), and a coolant fluid is flowing in coolant flow fields 22. The amount of heat conducted or removed from the oxidant in cathode flow fields 12 to the coolant fluid in coolant flow fields 22 is greater than the amount of heat conducted or removed from the fuel in anode flow fields 8 to the coolant fluid in coolant flow fields 22. Thus, if the reactants are supplied at the same temperature to the anode and cathode flow fields, the fuel will be at a higher temperature than the oxidant.

As mentioned before, creating different heat transfer rates for the anode and cathode flow field plate of each fuel cell is of particular importance for low pressure and low power operation, for example, less than about 0.21 barg and less than about 0.5 A/cm², respectively, in order to reduce parasitic power loss and to increase fuel efficiency. Preferably, only the stoichiometrically required amount of fuel is supplied to the anode flow fields because this reduces the amount of power needed to run the blowers and/or fans that deliver the fuel and improves fuel utilization, thereby improving fuel efficiency. However, this approach minimizes the amount of fuel being delivered to the anode flow fields, particularly if the fuel is 100% hydrogen and the temperature of the fuel cell is not particularly high (because voltage is high at low power), which may cause an inadequate flow velocity in the anode flow fields and too low of a fuel cell temperature to sufficiently remove water that has migrated from the cathode to the anode. At low pressure and low power operating conditions, it is preferable to keep water at the cathode because a relatively higher amount of oxidant is supplied to the cathode when using air as the oxidant (because air only comprises 21% oxygen), which means that the amount of oxidant being delivered to the cathode flow fields is significantly higher than the amount of fuel being delivered to the anode flow fields, and is also supplied at a significantly higher reactant flow velocity than the fuel.

One way of achieving different heat transfer rates for the anode flow field plate and the cathode flow field plate of each fuel cell during low pressure and low power operation is to use materials of different thermal conductivities for each plate, such that the thermal conductivity of cathode flow field plate 6 is greater than the thermal conductivity of anode flow field plate 4. For example, various blends of materials, such as carbon, graphite, metal and/or polymer, may be used to obtain the desired thermal conductivity of the anode and cathode flow field plates. In one example, different resins may be used for each of the flow field plates to vary its thermal conductivity. Alternatively, layered plate structures with different materials for each layer of the plate may also be used to control the thermal conductivity and/or heat transfer rate of each flow field plate during operation, such as incorporating a metallic layer to increase thermal conductivity or incorporating a relatively thermally insulating layer to decrease thermal conductivity, or using metallic plates with different coatings for the anode and cathode flow field plates. In another alternative, the amount of resin on one surface of the plate may be higher than an opposite surface of the flow field plate. In a further alternative, materials with anisotropic thermal properties may also be used as part of the layered structure to obtain and/or control the desired heat transfer rate of each flow field plate. One example of an anisotropic material is expanded graphite; its in-plane thermal conductivity is orders of magnitude greater than its through-plane thermal conductivity. One of ordinary skill in the art will recognize that although different materials and blends thereof may be used for the anode and cathode flow field plates, the coefficient of thermal expansion for each of the plate materials should not be so different as to create large thermal stresses in the bipolar flow field plate and the fuel cells.

Another way of achieving different heat transfer rates for the anode and cathode flow field plate of each fuel cell during low pressure and low power operation is to control their web thicknesses. The web thickness is defined as the cross-sectional distance of the bottom of a reactant flow field on the first surface of the flow field plate to the opposing second surface of the same flow field plate. In the case where the opposing second surface further comprises coolant flow fields, the web thickness is the distance from the bottom of the reactant fluid flow field to a bottom of the coolant flow field.

For example, in FIG. 1, anode plate web thickness 34 of anode flow field plate 4 is the distance from surface 36 of anode flow field 8 to second surface 18 of anode flow field plate 4. Similarly, for cathode flow field plate 6, cathode plate web thickness 35 is the distance from surface 38 of cathode flow field 12 to surface 40 of coolant flow field 22. A bipolar flow field plate 2 is formed by contacting second surface 18 of anode flow field plate 4 with second surface 20 of cathode flow field plate 8.

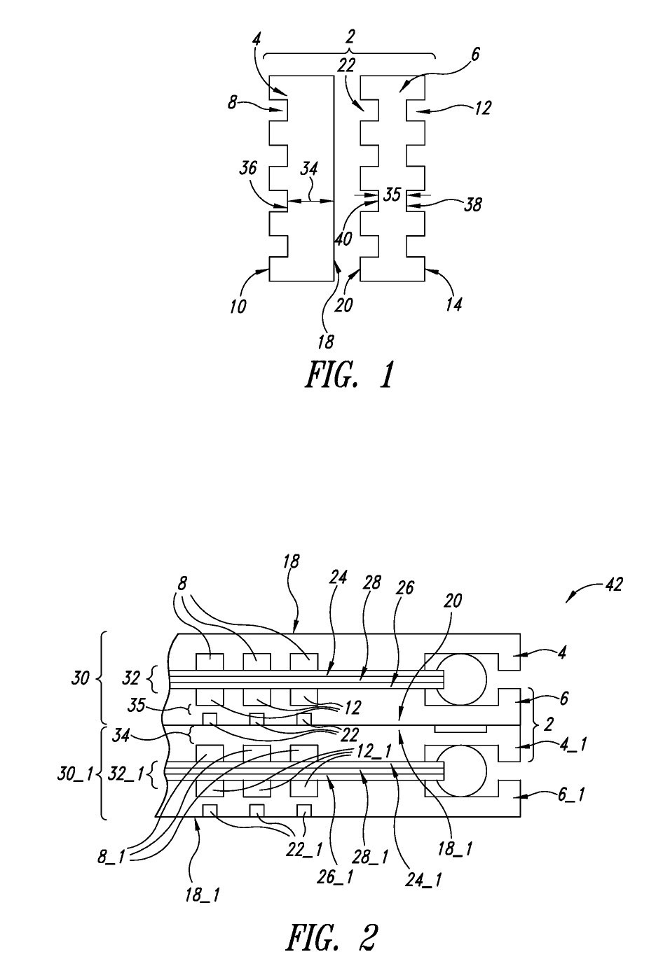

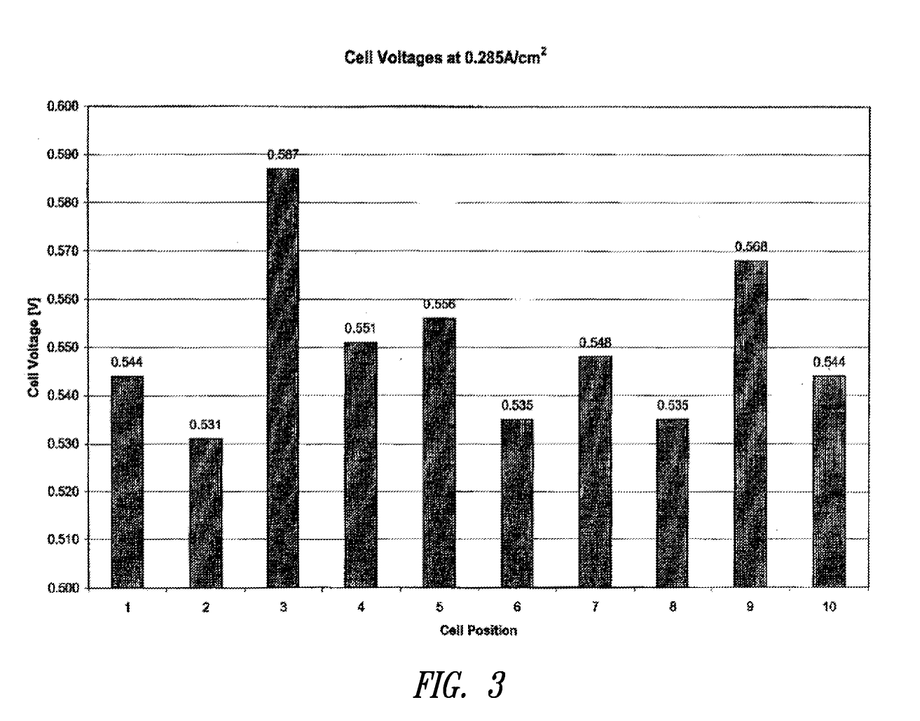

An embodiment of the present method is discussed in reference to FIG. 2. FIG. 2 shows fuel cell stack 42 comprising two fuel cells 30 and 30-1. Fuel cell 30 comprises anode flow field plate 4, cathode flow field plate 6 and MEA 32, wherein MEA 32 comprises anode electrode 24, cathode electrode 26, and membrane 28, and further-comprising anode flow fields 8, cathode flow fields 12, and coolant flow fields 22. Adjacent fuel cell 30-1 similarly comprises anode flow field plate 4-1, cathode flow field plate 6-1 and MEA 32-1 having anode electrode 24-1, cathode electrode 26-1, and membrane 28-1, and further comprising anode flow fields 8-1, cathode flow fields 12-1, and coolant flow fields 22-1.

During low pressure and low power operation of this fuel cell stack, a coolant fluid is circulated in coolant flow fields 22 on second surface 20 of cathode flow field plate 6, the coolant fluid being in contact with the second surface 18-1 of anode flow field plate 4-1 of fuel cell 30-1 to evenly remove and/or distribute heat within fuel cells 30 and 30-1. The temperature of the reactant fluid in anode flow fields 8-1 in contact with anode electrode 24-1 is different than the temperature of the reactant fluid in cathode flow fields 12 in contact with cathode electrode 26 due to the difference in relative plate web thicknesses (e.g., anode web thickness 34 is great than cathode web thickness 35). Preferably, the reactant fluid in the anode flow fields is maintained at a higher temperature than the reactant fluid in the cathode flow fields in order to reject more heat from the reactant in the cathode flow field than from the reactant to the anode flow field. This encourages water vapor condensation in cathode flow fields and minimizes water back-diffusion from the cathode of each fuel cell to the anode of the same fuel cell during low pressure and low power operation, thereby reducing anode flooding. The heat transfer rate of the cathode flow field plate is greater than the heat transfer rate of the adjacent anode flow field plate by the means previously described and/or other methods known in the art for passively inducing different heat transfer rates for the anode and the cathode flow field plates.

Referring to FIG. 2, fuel cell stack 42 may be formed by stacking fuel cell 30 next to an adjacent fuel cell 30-1 such that second surface 20 of cathode flow field plate 6 of fuel cell 30 is in contact with second surface 18-1 of anode flow field plate 4-1 of adjacent fuel cell 30-1. In fuel cell stack 42, coolant flow fields 22 and 22-1 are formed on the second surface of cathode flow field plates 6 and 6-1, respectively. For example, cathode flow field plate 6 of fuel cell 30 comprises coolant flow fields 22 so that a coolant fluid may flow between cathode flow field plate 6 of fuel cell 30 and anode flow field plate 4-1 of adjacent fuel cell 30-1. Again, during low pressure and low power operation, the heat transfer rate of the cathode flow field plate of each fuel cell is greater than the heat transfer rate of the adjacent anode flow field plate of an adjacent fuel cell, as discussed above.

In fuel cell stack 42, one or both of the second surfaces of anode flow field plates 4 and 4-1 and cathode flow field plates 6 and 6-1 may comprise coolant flow fields 22 and 22-1, respectively. Alternatively, no coolant flow fields may be present on the second surface of either anode flow field plate 4 or cathode flow field plate 6. Instead, bipolar flow field plate 2 further comprises an additional coolant plate disposed between second surface 18-1 of anode flow field plate 4-1 and second surface 20 of cathode flow field plate 6, and coolant flow fields are formed on the coolant plate (not shown). In one embodiment, the coolant flow field plate may be such that during low pressure and low power operation, it produces a higher heat transfer rate in the cathode flow field plate than the anode flow field plate (e.g., the amount of heat removed from the cathode flow field plate is greater than the amount of heat removed from the anode flow field plate) by using different materials with different thermal conductivities and/or by orienting the coolant flow fields such that they are closer to the cathode flow fields than the anode flow fields and/or other methods known in the art for passively inducing different heat transfer rates for the anode and the cathode flow field plates.

The following example is provided to illustrate certain aspects and embodiments of the invention but should not be construed as limiting in any way.

### EXAMPLE

Two 10-cell fuel cell stacks were tested under the following conditions: diluted fuel (74% hydrogen, 20% carbon dioxide, 6% nitrogen) was supplied to the anode at a pressure of 17.2 kPag, a humidification temperature of 57° C. and a stoichiometry of 1.25, while air was supplied to the cathode at a pressure of 10.7 kPag, a humidification temperature of 57° C. and a stoichiometry of 2.0. The anode flow fields of both stacks had a pressure drop of 120 mbar while the cathode flow fields of both stacks had a pressure drop of 100 mbar. The anode flow field plate web thickness of the anode flow field plates in the first stack was 1.88-millimeters, while the anode flow field plate web thickness of the anode flow field plates in the second stack was 3.6-millimeters. Both stacks were operated at 0.285 A/cm² for about 15 minutes.

FIG. 3 shows the average performance of each fuel cell in the first 10-cell stack comprising 1.88-millimeter web thickness anode flow field plates. The average performance was unstable and had a large cell-to-cell voltage variability, greater than 50 mV difference between the best performing cell and the worst performing cell. The average performance at 0.285 A/cm² was 544 mV.

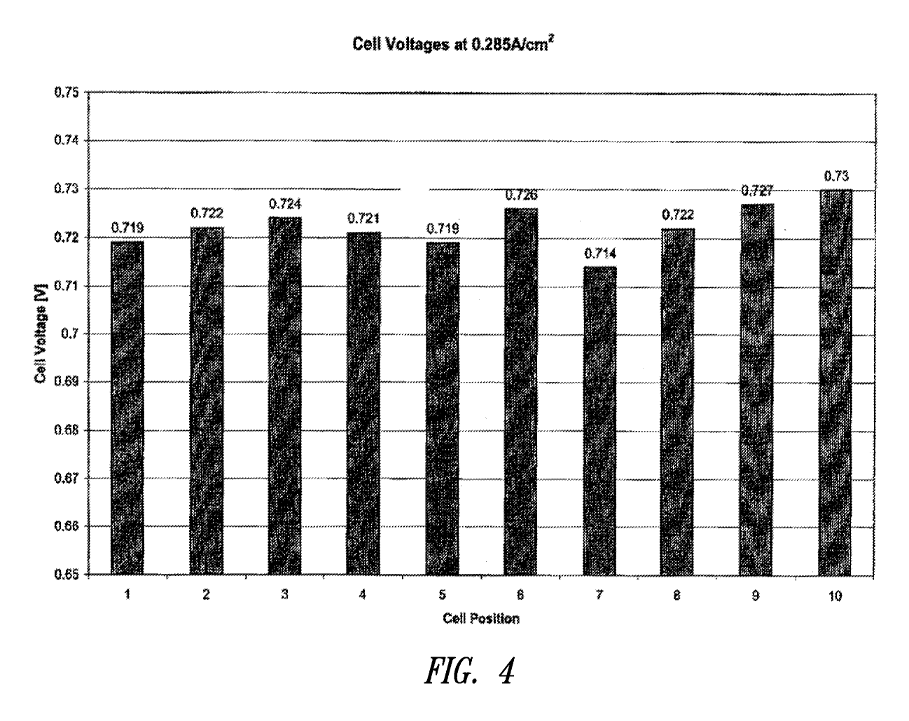

FIG. 4 shows the average performance of each fuel cell in the second 10-cell stack comprising 3.6-millimeter web thickness anode flow field plates. Performance was stable and had a much lower cell-to-cell voltage variability, less than 17 mV difference between the best performing cell and the worst performing cell. The average performance at 0.285 A/cm² was 722 mV, which was significantly better than the first 10-cell stack at only 544 mV.

A reduction in water back-diffusion from the cathode to the anode was verified by collecting water that was condensed from a water knockout at the anode outlet of the fuel cell. The same two 10-cell fuel cell stacks were operated for 8 hours at 0.221 A/cm². A total of 15.4 grams/hour of water was collected from the first 10-cell fuel cell stack while a total of only 1.2 grams/hour of water was collected from the second 10-cell fuel cell stack, thus illustrating the significant influence of anode flow field plate web thickness on water back-diffusion from the cathode to the anode and the reduction in anode flooding with low pressure drop anode flow fields.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

1. A method of operating a solid polymer electrolyte fuel cell stack having a plurality of fuel cells, the method comprising the steps of:
a) supplying a fuel at a pressure of less than 0.21 barg to at least one anode flow field of an anode flow field plate of each fuel cell;
b) supplying an oxidant at a pressure of less than 0.21 barg to at least one cathode flow field of a cathode flow field plate of each fuel cell; and
c) supplying a coolant to at least one coolant flow field;
wherein during fuel cell stack operation at a current density of less than 0.5 A/cm², the temperature of the anode flow field plate of each fuel cell is greater than the temperature of the cathode flow field plate of the same fuel cell.

2. The method of claim 1 wherein the fuel and oxidant are supplied by means of a blower or fan.

3. The method of claim 1 wherein during fuel cell stack operation at a current density of less than 0.5 A/cm², the temperature of the anode flow field plate of one fuel cell is greater than the temperature of the cathode flow field plate of an adjacent fuel cell.
